(19) United States
(12) Patent Application Publication
(10) Pub. No.: US 2024/0097583 A1
(43) Pub. Date: Mar. 21, 2024

(54) ENERGY HARVESTING OF INFRASTRUCTURE VIBRATIONS

(71) Applicant: RUTGERS, THE STATE UNIVERSITY OF NEW JERSEY, New Brunswick, NJ (US)

(72) Inventors: Hao WANG, Piscataway, NJ (US); Lukai GUO, Wesley Chapel, FL (US)

(21) Appl. No.: 18/244,493

(22) Filed: Sep. 11, 2023

Related U.S. Application Data
(60) Provisional application No. 63/405,614, filed on Sep. 12, 2022.

(51) Int. Cl. H02N 2/18; G06F 30/13

(52) U.S. Cl. CPC H02N 2/186; G06F 30/13; G06F 2119/06

(57) ABSTRACT

A computer-implemented method of automated design for a vibration-based energy harvesting system for a host structure includes receiving acceleration signals obtained from one or more accelerometers attached to the host structure, determining dominating acceleration frequencies of the host structure from the received acceleration signals, determining a degree-of-freedom number of a cantilever beam based on the number of dominating acceleration frequencies of the host structure, simulating vibration of the cantilever beam across a plurality of parameters, determining values of the plurality of parameters that result in a match between resonant frequencies of the cantilever beam and the dominating acceleration frequencies of the host structure, and outputting a proposed design of the cantilever beam including the values of the plurality of parameters.

### BACKGROUND

Energy harvesting systems and methods on pavements and bridges that rely on piezoelectric materials from direct traffic loads or structural vibrations have become increasingly important in the push for smart transportation infrastructure. Designs based on direct traffic loads require seamless integration with original pavement structures to ensure sufficient service life of both the pavement structures and the energy harvesters. However, since this can only happen when the pavement is originally built and/or repaved, the economic feasibility of these designs leads to slow implementation.

Designs based on structural vibrations tend to have longer service life due to no direct traffic loading impact. However, the traditional designs either employ multiple single-beam cantilevers, which raise cost significantly, or only allow for a single frequency to be captured. Furthermore, due to different bridges creating different and potentially multiple vibration frequencies during traffic loading, each system needs to be customized for the specific bridge and its vibration frequencies during traffic loading to optimize the power generated by that system.

### BRIEF SUMMARY

Systems and methods of energy harvesting from infrastructure vibrations and the automated design thereof are described herein. Advantageously, by determining dominating acceleration frequencies of a host structure, values of a plurality of parameters of a cantilever beam (e.g., of an energy harvesting system) that result in a match between resonant frequencies of the cantilever beam and the dominating acceleration frequencies of the host structure can be determined. Indeed, through the systems and methods described herein, it is possible to obtain a design of the cantilever beam that includes the values of the plurality of parameters enables efficient harvesting of energy of infrastructure vibrations of a host structure (e.g., a bridge).

A computer-implemented method of automated design for a vibration-based energy harvesting system for a host structure includes receiving acceleration signals obtained from one or more accelerometers attached to the host structure, determining dominating acceleration frequencies of the host structure from the received acceleration signals, determining a degree-of-freedom number of a cantilever beam based on the number of dominating acceleration frequencies of the host structure, simulating vibration of the cantilever beam across a plurality of parameters, determining values of the plurality of parameters that result in a match between resonant frequencies of the cantilever beam and the dominating acceleration frequencies of the host structure, and outputting a proposed design of the cantilever beam including the values of the plurality of parameters. The plurality of parameters includes a length and a width of the cantilever beam, a mass for each degree-of-freedom, positioning information of the mass for each degree-of-freedom, positioning information for a plurality of piezoelectric elements, geometric information of a first internal beam of the cantilever beam, a position of the first internal beam within the cantilever beam, or a combination thereof.

In some cases, determining dominating acceleration frequencies of the host structure from the received acceleration signals includes processing the received acceleration signals through a Fast Fourier Transform to determine the dominating acceleration frequencies of the host structure. In some cases, the degree-of-freedom number of the cantilever beam is determined to be two when the number of dominating acceleration frequencies of the host structure is two and the degree-of-freedom number of the cantilever beam is determined to be three when the number of dominating acceleration frequencies of the host structure is three. In some cases, when the degree-of-freedom number of the cantilever beam is determined to be two, a first mass is coupled to a fixed end of the cantilever beam and a second mass is coupled to the first internal beam of the cantilever beam. In some cases, when the degree-of-freedom number of the cantilever beam is determined to be three, the plurality of parameters further includes geometric information of a second internal beam of the cantilever beam, and a position of the second internal beam within the cantilever beam and substantially within the first internal beam of the cantilever beam.

A system for energy harvesting of infrastructure vibrations includes a cantilever beam including a first internal beam, a fixed end, and a free end, a first mass coupled to the fixed end of the cantilever beam, a second mass coupled to the first internal beam of the cantilever beam, and a plurality of piezoelectric elements coupled to the cantilever beam.

In some cases, the cantilever beam further includes a second internal beam, wherein the second internal beam is positioned substantially within the first internal beam. In some cases, the system further includes a third mass coupled to the second internal beam. In some cases, the first internal beam includes a fixed end proximal to the fixed end of the cantilever beam and a free end distal to the fixed end of the cantilever beam and the second internal beam includes a fixed end distal to the fixed end of the cantilever beam and a free end proximal to the fixed end of the cantilever beam. In some cases, the second mass is coupled proximally to the free end of the first internal beam and the third mass is coupled proximally to the free end of the second internal beam. In some cases, the first mass is integrated into the fixed end of the cantilever beam, the second mass is integrated into the free end of the first internal beam, and/or the third mass is integrated into the free end of the second internal beam.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a computer-implemented method of automated design for a vibration-based energy harvesting system for a host structure.

FIGS. 2A and 2B illustrate cantilever beams having internal beams.

FIGS. 3A-3D illustrate example two degree-of-freedom cantilever beam designs.

FIGS. 4A and 4B illustrate example three degree-of-freedom cantilever beam designs.

FIGS. 5A and 5B are photographs of prototype designs. FIG. 5A illustrates a two degree-of-freedom cantilever beam and FIG. 5B illustrates a three degree-of-freedom cantilever beam of the prototype designs.

FIG. 6 is a photograph of a live load applied on bridge deck at a full-scale bridge test facility.

FIG. 7 illustrates girder spacing information of a bridge.

FIGS. 8A-8C are photographs of testing instruments set up on a bridge girder.

FIGS. 9A and 9B illustrate voltage outputs from the macro-fiber-composites of the prototype designs.

FIGS. 10A and 10B illustrate resonance frequency outputs of a regression model versus FEM results in a two degree-of freedom cantilever beam.

FIGS. 11A-11C illustrate resonance frequency outputs of a regression model versus FEM results in a three degree-of freedom cantilever beam.

FIG. 12 illustrates Fast Fourier Transform applied to acceleration signals of a bridge.

FIG. 13 illustrates resonant frequencies of cantilever beam designs measured in the laboratory versus estimated using a regression model of FEM results.

FIGS. 14A-14C illustrate energy outputs from initial cantilever designs versus an optimized cantilever design in a two degree-of-freedom cantilever beam.

FIGS. 15A-15C illustrate energy outputs from initial cantilever designs versus an optimized cantilever design in a three degree-of-freedom cantilever beam.

### DETAILED DESCRIPTION

Systems and methods of energy harvesting from infrastructure vibrations and the automated design thereof are described herein. Advantageously, by determining dominating acceleration frequencies of a host structure, values of a plurality of parameters of a cantilever beam (e.g., of an energy harvesting system) that result in a match between resonant frequencies of the cantilever beam and the dominating acceleration frequencies of the host structure can be determined. Indeed, through the systems and methods described herein, it is possible to obtain a design of the cantilever beam that includes the values of the plurality of parameters enables efficient harvesting of energy of infrastructure vibrations of a host structure (e.g., a bridge).

Given the variety of vibration features from different host structures (e.g., bridges) under different external conditions, it is beneficial to customize energy harvesting systems for each host structure to maximize energy output and/or efficiency. A first step to customize an energy harvesting system for a specific host structure is to collect acceleration signals of the host structure. In some cases, this may be done by placing accelerometers on the host structure. For example, the host structure may be a bridge, and an accelerometer may be placed on several girders of the bridge to capture the accelerations signals of the bridge. In some cases, the captured the accelerations signals of the host structure are directly sent to a computing system for automated design for a vibration-based energy harvesting system (e.g., over wired or wireless connection). In some cases, the captured the accelerations signals of the host structure are stored (e.g., onsite or on a separate device that receives the signals over wired or wireless connection) and provided for later use to a computing system for automated design for a vibration-based energy harvesting system. In some cases, the system that captures the accelerations signals of the host structure may be considered a part of a computing system for automated design for a vibration-based energy harvesting system.

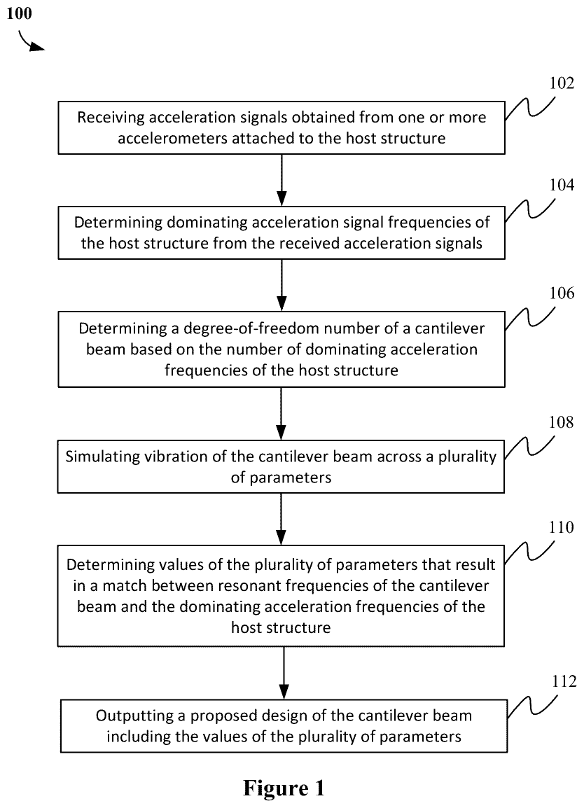

FIG. 1 illustrates a computer-implemented method of automated design for a vibration-based energy harvesting system for a host structure. Referring to FIG. 1, the method 100 includes receiving (102) acceleration signals obtained from one or more accelerometers attached to the host structure, determining (104) dominating acceleration signal frequencies of the host structure from the received acceleration signals, and determining (106) a degree-of-freedom number of a cantilever beam based on the number of dominating acceleration frequencies of the host structure.

In some cases, determining (104) dominating acceleration signals frequencies of the host structure from the received acceleration signals includes processing the received acceleration signals through a Fast Fourier Transform to determine the dominating acceleration frequencies of the host structure.

In some cases, determining (106) the degree-of-freedom number of the cantilever beam based on the number of dominating acceleration frequencies of the host structure includes selecting two or three of the most dominating acceleration frequencies of the host structure and setting the degree-of-freedom number equal to the number (e.g., two or three) of the most dominating acceleration frequencies of the host structure.

The method 100 further includes simulating (108) vibration of the cantilever beam across a plurality of parameters, determining (110) values of the plurality of parameters that result in a match between resonant frequencies of the cantilever beam and the dominating acceleration frequencies of the host structure, and outputting (112) a proposed design of the cantilever beam including the values of the plurality of parameters.

The plurality of parameters includes a length and a width of the cantilever beam, a mass for each degree-of-freedom, positioning information of the mass for each degree-of-freedom, positioning information for a plurality of piezoelectric elements, geometric information of a first internal beam of the cantilever beam, a position of the first internal beam within the cantilever beam, or a combination thereof. In some cases, the length and the width of the cantilever beam is 170 mm×70 mm. In some cases, the mass for each degree-of-freedom is optimized to match resonant frequencies of the cantilever beam and the dominating acceleration frequencies of the host structure.

The simulations can be performed using built-in simulation tools of the software performing method 100 or may be any suitable available simulation tool called (e.g., by application programming interface (API) or by any other mechanism by which an application communicates with another application) by the software performing method 100. Example available simulation software and software packages include MathWorks MATLAB, Dassualt Systemes ABAQUS, COMSOL Multiphysics, and ANSYS. In some cases, simulating (108) vibration of the cantilever beam across a plurality of parameters includes using finite element models (FEMs) of a vibration-based energy harvester. The details of the FEMs may involve multiple software modules, including a Solid Mechanics module for simulating the mechanical vibration of the cantilever beam, an Electrostatics module for counting the charge generation from piezoelectric elements, and an Electrical Circuit module for quantifying the power output from piezoelectric elements.

In the Solid Mechanics module, a prescribed acceleration, a_{z}, can be set on the connection between the cantilever beam and the host structure, as described in equation [1]. The mass force, Fᵥ, can be set on the other end of the beam within the area of the mass as another boundary condition, as described in equation [2].

a_{z}=−ω²u_{z} [1]

where ω is the vibration frequency and u_{z} is the displacement in the vertical direction.

$${F}_{v} = - \frac{m}{v} ( - {ω}^{2} u + {a}_{f} ) \qquad [ 2 ]$$

where u is the displacement, a_{f} is the free fall acceleration, and v is the volume of the mass.

In the Electrostatics module, the charging conservation can be set on piezoelectric elements and is governed by equations [3] and [4]. A ground voltage, V=0, is set on the bottom of the piezoelectric element, while a terminal voltage, Vₜ, is set on the top of the piezoelectric element.

E=−∇V [3]

∇*D=ρᵥ [4]

where E is the electric field, D is the electric displacement field, V is the voltage, and ρᵥ is the volume charge density.

In the electrical circuit module, a ground node (node 0) can be connected to terminal nodes on piezoelectric elements. The voltage output value of terminal nodes in this electrical circuit module is from the terminal voltage outputs in the electrostatics module.

In some cases, method 100 includes automatic selection of materials or an input mechanism for user selection of materials of the cantilever-based energy harvesting device. Material selection may include 5052 aluminum for the cantilever beam (or other similar materials), polyimide for coating on the piezoelectric elements (or other similar materials), and the materials of the piezoelectric elements themselves (e.g., provided by the manufacturer). In some cases, the piezoelectric elements are macro-fiber composites (MFCs). The simulations can include modeling for the particular selection of materials.

Using the results of the simulations, values of the plurality of parameters that result in a match between resonant frequencies of the cantilever beam and the dominating acceleration frequencies of the host structure can be determined (110).

In some cases, determining (110) values of the plurality of parameters that result in a match between resonant frequencies of the cantilever beam and the dominating acceleration frequencies of the host structure includes machine learning algorithms (e.g., support vector regression, random forest, extreme gradient boosting).

In some cases, determining (110) values of the plurality of parameters that result in a match between resonant frequencies of the cantilever beam and the dominating acceleration frequencies of the host structure includes simple, multiple linear, and/or nonlinear regression models. For example, a cantilever beam simulation can be conducted with one set of parameters and if the resonant frequencies of the cantilever beam are ±0.5 Hz from the dominating acceleration frequencies of the host structure, the mass is adjusted until the resonant frequencies of the cantilever beam and the dominating acceleration frequencies of the host structure are sufficiently matching (e.g., less than ±0.5 Hz, ±0.45 Hz, ±0.40 Hz, ±0.4 Hz, ±0.3 Hz, ±0.2 Hz, etc.).

For regression models, equations [5] and [6] below represent mass selection for two degree-of-freedom and equations [7]-[9] represent mass selection for three degree-of-freedom cantilever beams.

Two degree-of-freedom cantilever:

Y_{2,1}=14.6240−0.4863X_{2,1}+0.0127X_{2,1}²−0.0001X_{2,1}³,R²=0.9996 [5]

Y_{2,2}=22.722−0.9712X_{2,2}+0.0303X_{2,2}²−0.0004X_{2,2}³,R²=0.9953 [6]

Three degree-of-freedom cantilever:

Y_{3,1}=10.6888−0.08358X_{3,1}−0.0765X_{3,2},R²=0.8885 [7]

Y_{3,2}=20.629−0.7171X_{3,2}+0.0187X_{3,2}−0.0002X_{3,2},R²=0.9999 [8]

Y_{3,3}=33.560+0.0480X_{3,1}−0.1436X_{3,3}−0.0177X_{3,1}*X_{3,3},R²=0.8372 [9]
where Y_{2,1}, Y_{2,2}, Y_{3,1}, Y_{3,2}, and Y_{3,3} respectively represent resonant frequency of a two degree-of-freedom cantilever beam in vibration mode 1, a two-degree-of-freedom cantilever beam in vibration mode 2, a three-degree-of-freedom cantilever beam in vibration mode 1, a three-degree-of-freedom cantilever beam in vibration mode 2, and a three-degree-of-freedom cantilever beam in vibration mode 3; X_{2,1}, X_{2,2}, X_{3,1}, X_{3,2}, and X_{3,3} respectively represent mass 1 on a two degree-of-freedom cantilever beam, mass 2 on a two degree-of-freedom cantilever beam, mass 1 on a three degree-of-freedom cantilever beam, mass 2 on a three degree-of-freedom cantilever beam, and mass 3 on a three degree-of-freedom cantilever beam.

In some cases, outputting (112) a proposed design of the cantilever beam including the values of the plurality of parameters includes sending the proposed design of the cantilever beam including the values of the plurality of parameters from the computing system performing method 100 to another computing system over a network directly (e.g., the Internet, local area network, wide area network, peer to peer communication, etc.) or by a particular communication channel (e.g., via email, text message, or other form of electronic communication). In some cases, outputting (112) a proposed design of the cantilever beam including the values of the plurality of parameters includes displaying proposed design of the cantilever beam including the values of the plurality of parameters on a display associated with the computing system performing method 100.

Method 100 can be implemented by any suitable computing system, including, but not limited to a desktop, laptop, tablet, server, and smartphone.

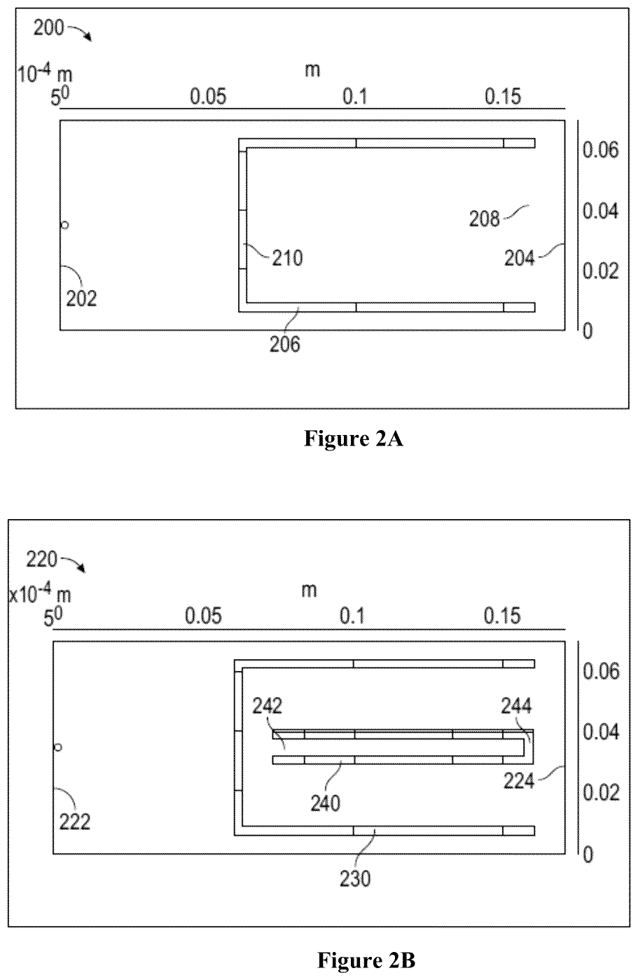

FIGS. 2A, 2B, 3A, 3B, 3C, 3D, 4A, and 4B illustrate example cantilever components and designs.

FIGS. 2A and 2B illustrate cantilever beams having internal beams. FIG. 2A shows a cantilever beam 200 with two degrees of freedom. FIG. 2B shows a cantilever beam 220 with three degrees of freedom. Referring to FIG. 2A, a cantilever beam 200 includes a free end 202, a fixed end 204, and a first internal beam 206. In some cases, the first internal beam 206 includes a fixed end 208 proximal to the fixed end 204 of the cantilever beam 200 and a free end 210 distal to the fixed end 204 of the cantilever beam 200. Referring to FIG. 2B, a cantilever beam 220 includes a free end 222, a fixed end 224, a first internal beam 230, and a second internal beam 240. In some cases, the second internal beam 240 includes a fixed end 242 distal to the fixed end 224 of the cantilever beam 220 and a free end 244 proximal to the fixed end 224 of the cantilever beam 220. In some cases, the internal beams 206, 230, 240 are cut into the cantilever beam 200, 220 via laser-cutting techniques. In some cases, the internal beams 206, 230, 240 are formed into the cantilever beam 200, 220 during construction of the cantilever beam 200, 220.

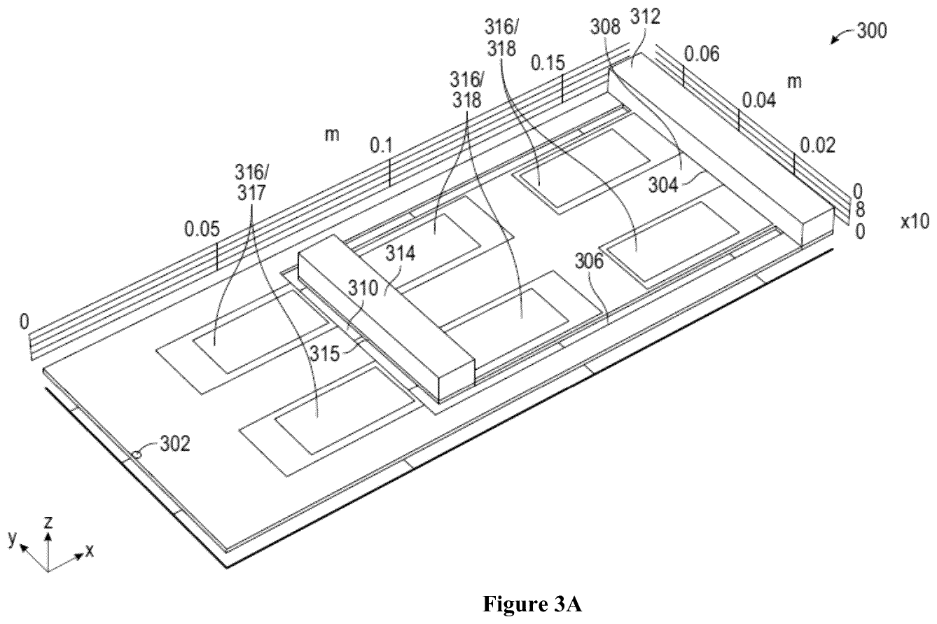

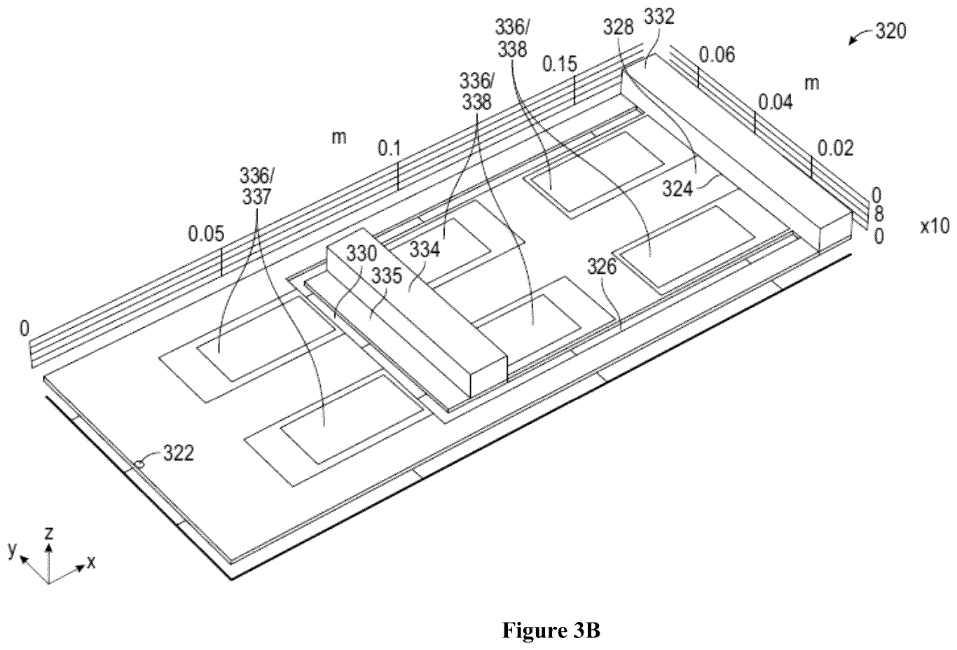

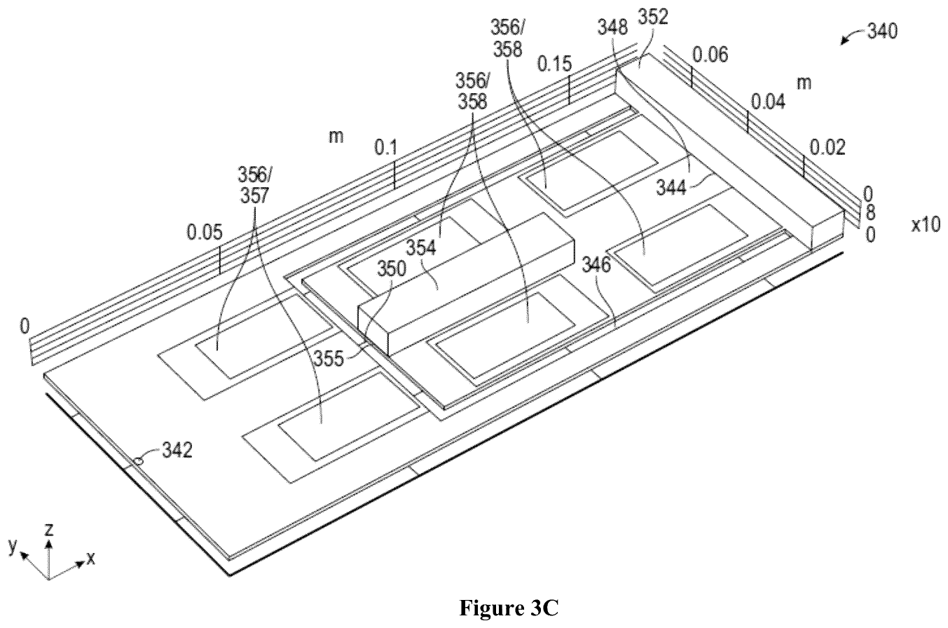

FIGS. 3A-3D illustrate example two degree-of-freedom cantilever beam designs. These two degree-of-freedom cantilever beams illustrate specific examples of determined values and/or arrangements of some of the plurality of parameters that may be used in an automated design for a vibration-based energy harvesting system for a host structure. Referring to FIGS. 3A-3D, a cantilever beam 300, 320, 340, 360 includes a free end 302, 322, 342, 362, a fixed end 304, 324, 344, 364, and a first internal beam 306, 326, 346, 366. In some cases, the first internal beam 306, 326, 346, 366 includes a fixed end 308, 328, 348, 368 proximal to the fixed end 304, 324, 344, 364 of the cantilever beam 300, 320, 340, 360 and a free end 310, 330, 350, 370 distal to the fixed end 304, 324, 344, 364 of the cantilever beam 300, 320, 340, 360. In some cases, the free end 310, 330, 350, 370 of the first internal beam 306, 326, 346, 366 is proximal to the free end 302, 322, 342, 362 of the cantilever beam 300, 320, 340, 360. The cantilever beam 300, 320, 340, 360 further includes a first mass 312, 332, 352, 372 coupled to the fixed end 304, 324, 344, 364 of the cantilever beam 300, 320, 340, 360 and a second mass 314, 334, 354, 374 coupled to the first internal beam 306, 326, 346, 366 of the cantilever beam 300, 320, 340, 360. The first mass 312, 332, 352, 372 is coupled to the fixed end 304, 324, 344, 364 of the cantilever beam 300, 320, 340, 360 in a transverse direction with respect to the cantilever beam 300, 320, 340, 360.

Referring to FIG. 3A, the second mass 314 is coupled proximally to the free end 310 of the first internal beam 306 of the cantilever beam 300. Specifically, the second mass 314 is coupled at an edge 315 of the free end 310 of the first internal beam 306 of the cantilever beam 300. The second mass 314 is coupled at the edge 315 of the free end 310 of the first internal beam 306 of the cantilever beam 300 in a transverse direction with respect to the cantilever beam 300. A plurality of piezoelectric elements 316 are coupled to the cantilever beam 300. In the illustrated example, the plurality of piezoelectric elements 316 includes two piezoelectric elements 317 coupled to the free end 302 of the cantilever beam 300 and four piezoelectric elements 318 coupled within the first internal beam 306 of the cantilever beam 300. It should be understood that more or fewer piezoelectric elements 316 may be used (and the sizes and orientations may also be varied).

Referring to FIG. 3B, the second mass 334 is coupled proximally to the free end 330 of the first internal beam 326 of the cantilever beam 320. Specifically, the second mass 334 is coupled a distance away from an edge 335 of the free end 330 of the first internal beam 326 of the cantilever beam 320. In the illustrated example, the second mass 334 is coupled in a transverse direction with respect to the cantilever beam 320. The distance from the edge 335 is a parameter that can be varied. A plurality of piezoelectric elements 336 are coupled to the cantilever beam 320. In the illustrated example, the plurality of piezoelectric elements 336 includes two piezoelectric elements 337 coupled to the free end 322 of the cantilever beam 320 and four piezoelectric elements 338 coupled within the first internal beam 326 of the cantilever beam 320. It should be understood that more or fewer piezoelectric elements 336 may be used (and the sizes and orientations may also be varied).

Referring to FIG. 3C, the second mass 354 is coupled proximally to the free end 350 of the first internal beam 346 of the cantilever beam 340. Specifically, the second mass 354 is coupled at an edge 355 of the free end 350 of the first internal beam 346 of the cantilever beam 340. In the illustrated example, the second mass 354 is coupled in a longitudinal direction with respect to the cantilever beam 340. A plurality of piezoelectric elements 356 are coupled to the cantilever beam 340. In the illustrated example, the plurality of piezoelectric elements 356 includes two piezoelectric elements 357 coupled to the free end 342 of the cantilever beam 340 and four piezoelectric elements 358 coupled within the first internal beam 346 of the cantilever beam 340. It should be understood that more or fewer piezoelectric elements 356 may be used (and the sizes and orientations may also be varied).

Referring to FIG. 3D, the second mass 374 is coupled in a central location 375 of the first internal beam 366 of the cantilever beam 360. In the illustrated example, the second mass 374 is coupled in a longitudinal direction with respect to the cantilever beam 360. A plurality of piezoelectric elements 376 are coupled to the cantilever beam 360. In the illustrated example, the plurality of piezoelectric elements 376 includes two piezoelectric elements 377 coupled to the free end 362 of the cantilever beam 360 and four piezoelectric elements 378 coupled within the first internal beam 366 of the cantilever beam 360. It should be understood that more or fewer piezoelectric elements 376 may be used (and the sizes and orientations may also be varied).

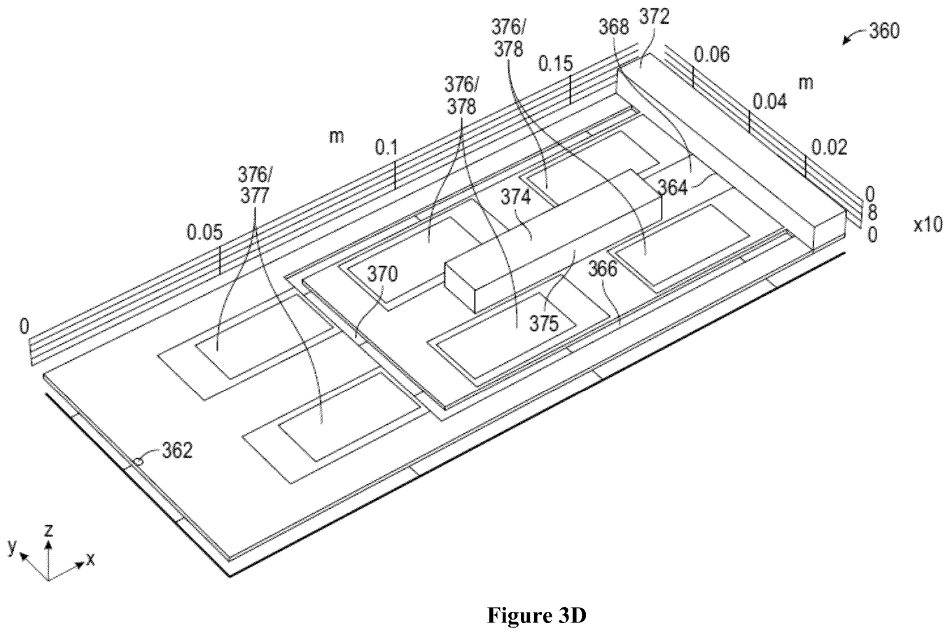

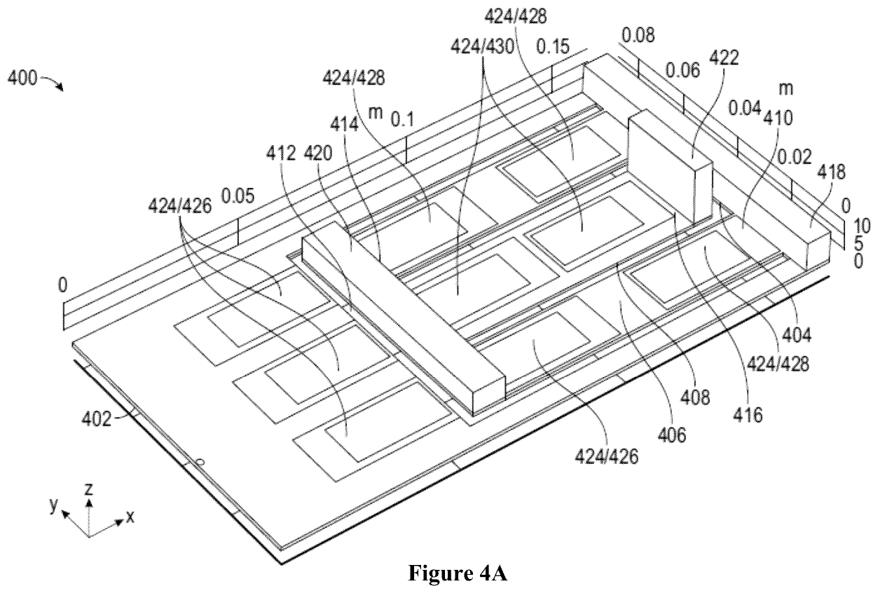

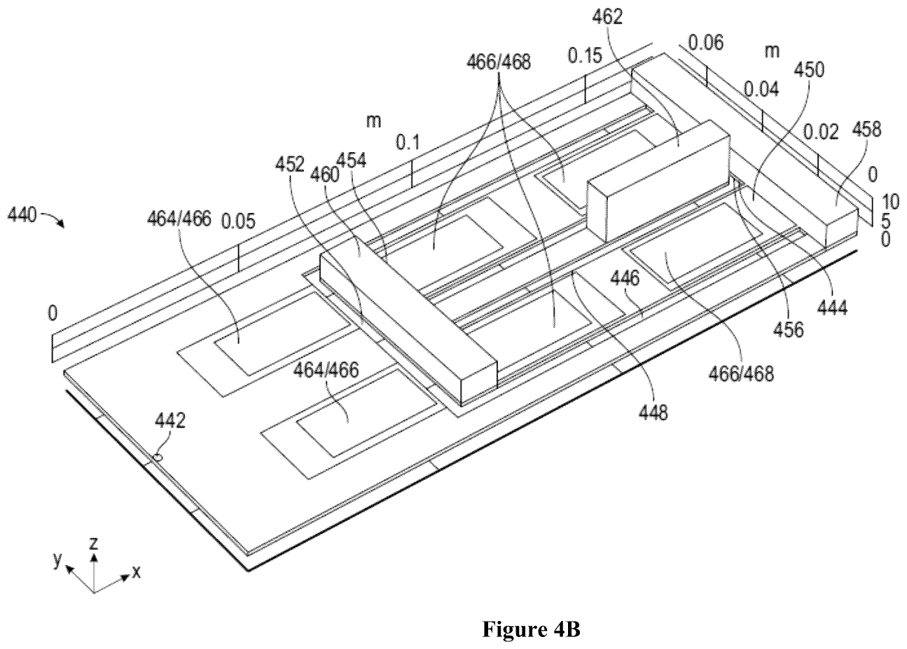

FIGS. 4A and 4B illustrate example three degree-of-freedom cantilever beam designs. These three degree-of-freedom cantilever beams illustrate specific examples of determined values and/or arrangements of some of the plurality of parameters that may be used in an automated design for a vibration-based energy harvesting system for a host structure. Referring to FIGS. 4A and 4B, a cantilever beam 400, 440 includes a free end 402, 442, a fixed end 404, 444, a first internal beam 406, 446, and a second internal beam 408, 448. In some cases, the first internal beam 406, 446 includes a fixed end 410, 450 proximal to the fixed end 404, 444 of the cantilever beam 400, 440 and a free end 412, 452 distal to the fixed end 404, 444 of the cantilever beam 400, 440. In some cases, the second internal beam 408, 448 includes a fixed end 414, 454 distal to the fixed end 404, 444 of the cantilever beam 400, 440 and a free end 416, 456 proximal to the fixed end 404, 444 of the cantilever beam 400, 440.

The cantilever beam 400, 440 further includes a first mass 418, 458 coupled to the fixed end 404, 444 of the cantilever beam 400, 440, a second mass 420, 460 coupled to the first internal beam 406, 446 of the cantilever beam 400, 440, and a third mass 422, 462 coupled to the second internal beam 408, 448 of the cantilever beam 400, 440. The first mass 418, 458 is coupled to the fixed end 404, 444 of the cantilever beam 400, 440 in a transverse direction with respect to the cantilever beam 400, 440. The second mass 420, 460 is coupled proximally to the free end 412, 452 of the first internal beam 406, 446 of the cantilever beam 400, 440 in a transverse direction with respect to the cantilever beam 400, 440. However, in some implementations, the second mass may be formed in multiple pieces and arranged on the first internal beam 406, 446 at various locations. The third mass 422, 462 is coupled proximally to the free end 416, 456 of the second internal beam 408, 448 of the cantilever beam 400, 440.

Referring to FIG. 4A, the third mass 422 is coupled proximally to the free end 416 of the second internal beam 408 of the cantilever beam 400 in a transverse direction with respect to the cantilever beam 400. A plurality of piezoelectric elements 424 are coupled to the cantilever beam 400. In the illustrated example, the plurality of piezoelectric elements 424 includes three piezoelectric elements 426 coupled proximally to the free end 402 of the cantilever beam 400, four piezoelectric elements 428 coupled within the first internal beam 406 of the cantilever beam 400, and two piezoelectric elements 430 coupled within the second internal beam 408 of the cantilever beam 400. It should be understood that more or fewer piezoelectric elements 424 may be used (and the sizes and orientations may also be varied).

Referring to FIG. 4B, the third mass 462 is coupled proximally to the free end 456 of the second internal beam 448 of the cantilever beam 400 in a longitudinal direction with respect to the cantilever beam 440. A plurality of piezoelectric elements 464 are coupled to the cantilever beam 440. In the illustrated example, the plurality of piezoelectric elements 464 includes two piezoelectric elements 466 coupled proximally to the free end 442 of the cantilever beam 440 and four piezoelectric elements 468 coupled within the first internal beam 446 of the cantilever beam 440. It should be understood that more or fewer piezoelectric elements 464 may be used (and the sizes and orientations may also be varied).

In some cases, as opposed to be coupled to the cantilever beam, as illustrated in FIGS. 3A-3D and FIGS. 4A and 4B, a mass for one or more degree of freedom (e.g., first mass, second mass, and/or third mass) may be integrated into the cantilever beam (or more specifically with respect to a second mass and/or third mass, integrated into the corresponding internal beam of the cantilever beam) itself. In some cases, the mass may be integrated into the cantilever beam (e.g., a first mass) while another mass is coupled to (an internal beam of) the cantilever beam (e.g., a second mass).

Prototype Designs

Prototype designs were created using acceleration signals collected from accelerometers attached to girders on a bridge. The resulting designs were tested in the laboratory.

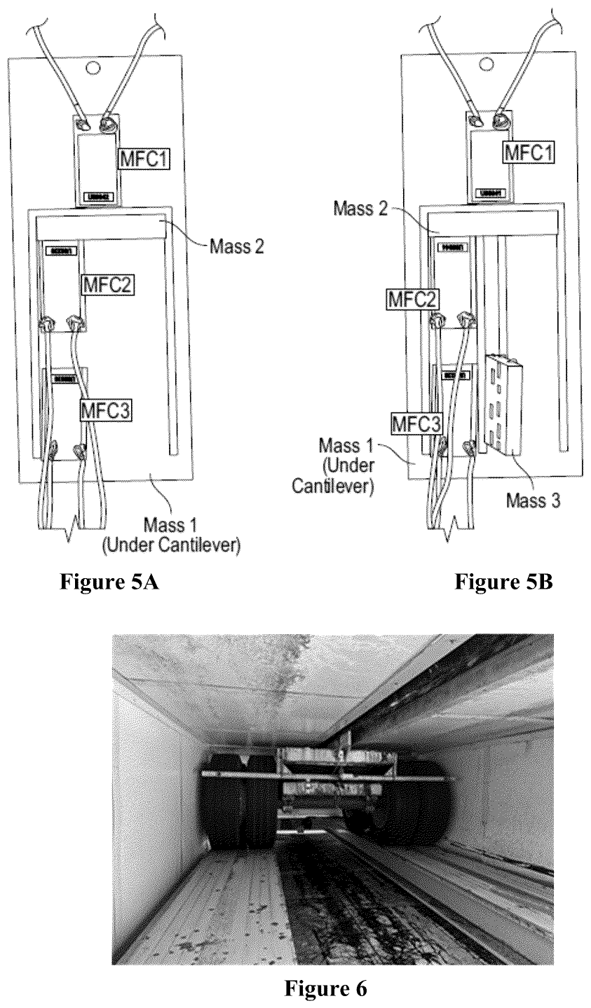

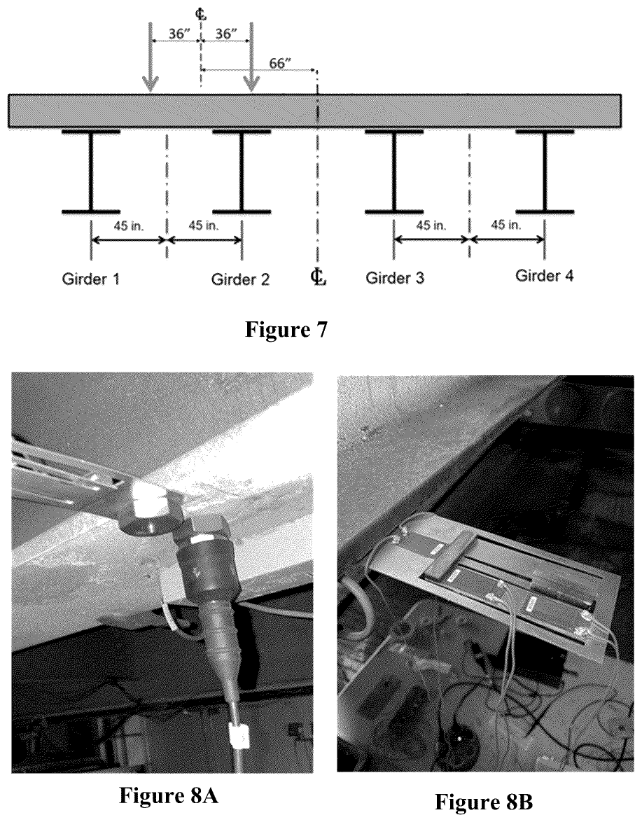

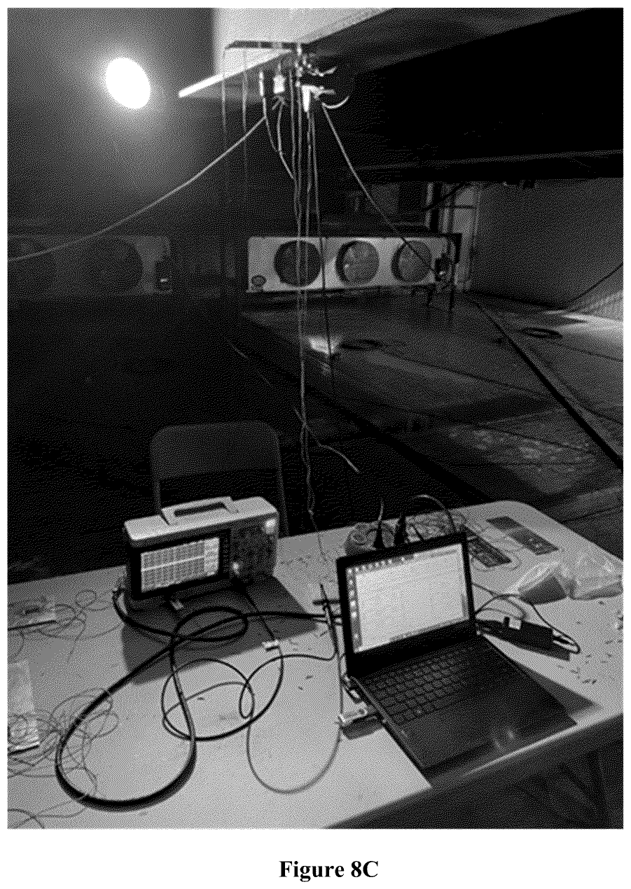

FIGS. 5A and 5B are photographs of prototype designs. FIG. 5A illustrates a two degree-of-freedom cantilever beam and FIG. 5B illustrates a three degree-of-freedom cantilever beam of the prototype designs. FIG. 6 is a photograph of a live load applied under a bridge. FIG. 7 illustrates girder spacing information of a bridge. FIGS. 8A-8C are photographs of testing instruments set up on a bridge.

Referring to FIGS. 5A and 5B, the inventors used laser-cutting techniques to create internal beams on the cantilever beams. One mass was added to each cantilever beam and each internal beam. MFCs were attached to the cantilever beams to harvest energy.

MFC1, MFC2, and MFC3 were respectively defined as the one close to the hole, the one in the middle, and the one close to the mass tip on the main beam. Conductive epoxy adhesive was used to connect the wires with the electrodes on each MFC in a low temperature method to ensure good conductivity without damaging the MFC. Cyanoacrylate super glue was used to bond the MFCs and the cantilevers for minimizing the energy loss from their interface.

A consistent outline dimension in 170×70×1 mm³ was used in both 2-DOF and 3-DOF cantilevers. Mass 1, Mass 2, and Mass 3 respectively represented the mass tip on the main beam, the secondary internal beam (for both 2-DOF and 3-DOF cantilever), and the third internal beam (for 3-DOF cantilever only). An initial series of mass combinations were also tried on both cantilever designs (Mass 1: 0 g, 6 g, and 10 g; Mass 2: 0 g, 21 g; Mass 3: 30 g) as baselines for further comparison with optimized designs.

The bridge structural vibration with multiple frequencies close to the field condition was simulated under one full-scale bridge model, the Bridge Evaluation and Accelerated Structural Testing System (BEAST) located on the campus of Rutgers University in New Jersey. The BEAST is capable of applying a live load from a tandem axle group (20˜60 kips under up to 20 mph) on an 8-inch concrete deck, as shown in FIG. 6. The entire composite concrete deck is 50 feet long by 28 feet wide, supported by four girders. In this study, a dynamic load of 60 kips was applied on the side of Girder 1 and Girder 2, as shown in FIG. 7. Given the bridge vibration was varied by uncertain traffic speeds, two loading speeds, 6 mph and 12 mph, were tried in this study to get different acceleration scenarios.

The acceleration of this full-scale bridge model was measured by the accelerometer attached on the girder, where was close to the cantilever installation location, as shown in FIG. 8A. The type of accelerometer was an Integrated Circuit-Piezoelectric accelerometer in PCB Model 393A03, which was capable of measuring accelerations in a range of 5 g under a frequency from 0.5 to 2000 Hz. To ensure the measurement flexibility and accuracy, strong magnetics were used to fix the accelerometer on the girder. The acceleration signals were continuously input from the accelerometer to store in one local data acquisition system.

For the cantilever installation in the BEAST, as can be seen from FIGS. 8A and 8B, one end of the cantilever was also set on the girder fixed by a magnetic. To quantify the power output from the piezoelectric element on the cantilever, one external resistor was connected with the piezoelectric element by wires and one oscilloscope was used to measure and store the voltage output information across the external resistor, as shown in FIG. 8C.

Next, the inventors developed Finite Element Models as described above with respect to equations [1]-[4] that were developed using COMSOL. For verification purposes, all cantilever designs in multiple DOFs (2-DOF, and 3-DOF) were further tested in the laboratory, with the consistent material selections and vibration conditions.

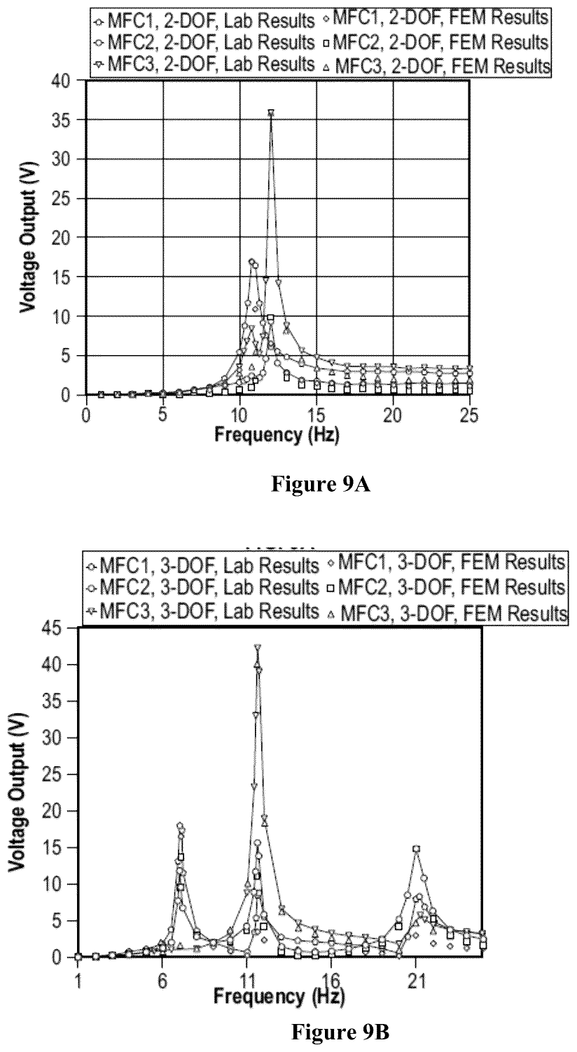

FIGS. 9A and 9B illustrate voltage outputs from the macro-fiber-composites of the prototype designs. Referring to FIGS. 9A and 9B, the consistent voltage outputs from each of the MFCs (MFC1, MFC2, MFC3) on the two degree-of-freedom and three degree-of-freedom designs, respectively are shown. It can be seen that the laboratory test results and FEM results agree.

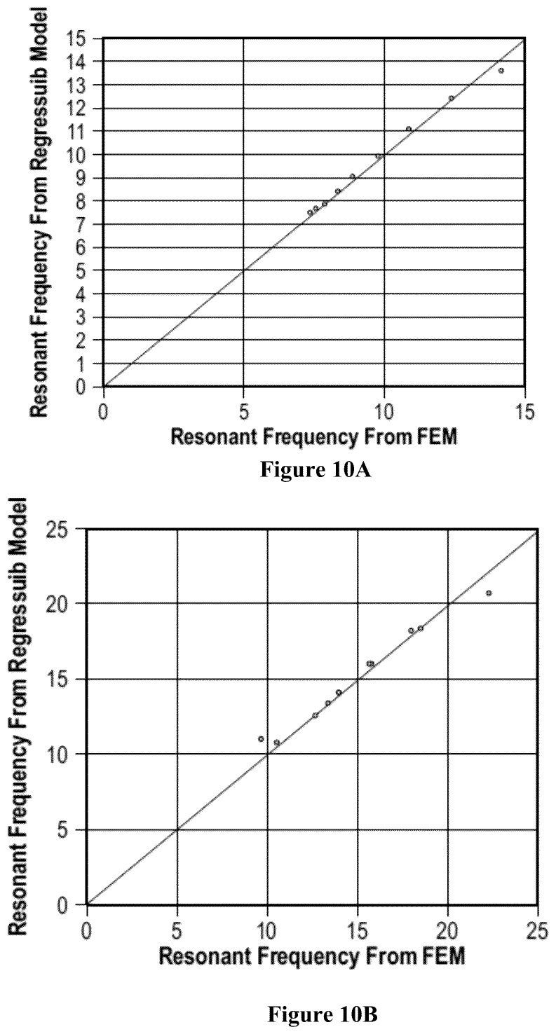

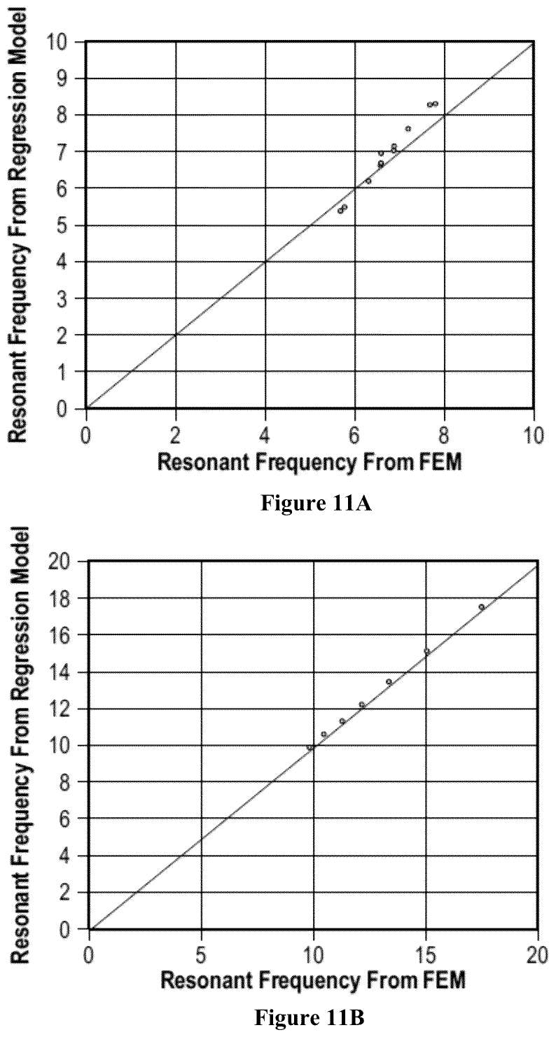

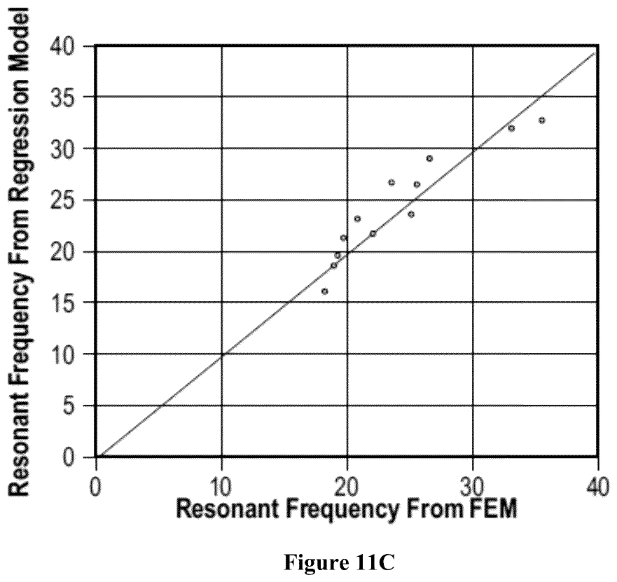

FIGS. 10A and 10B illustrate resonance frequency outputs of a regression model versus FEM results in a two degree-of freedom cantilever beam; and FIGS. 11A-11C illustrate resonance frequency outputs of a regression model versus FEM results in a three degree-of freedom cantilever beam.

After the FEMs of multiple-DOF cantilevers were built by the COMSOL and verified in the laboratory tests, the mass selections on 2-DOF and 3-DOF to reach the expected resonant frequencies were efficiently performed via nonlinear regression models, as described above with respect to equations [5]-[9].

As can be seen in FIGS. 10A and 10B, for 2-DOF cantilever design, the resonant frequencies in vibration mode 1 and mode 2 can be estimated by the given mass tips at a high confidence level. However, the predicted resonant frequency of vibration mode 1 could be more confident than that of vibration mode 2, as comparing the scatter points at lowest and highest resonant frequencies in FIGS. 10A and 10B. For the 3-DOF cantilever design, as shown in FIGS. 11A-11C, the resonant frequency in vibration mode 2 can be confidently predicted by the mass tip 2, and the resonant frequency in vibration mode 1 still remains an acceptable Goodness of Fit with two mass tips. However, predicting the resonant frequency in vibration mode 3 by two-mass combination are challenging with a weaker Goodness of Fit, but the scatter points away from the diagonal line are within controlled deviations.

Considering the power output from each piezoelectric element generated by a live load is in a pulse form, it is dynamic and varied by specific time periods. Instantaneous power outputs at peak voltage outputs can fail to count the total collected energy from the cantilevers. Therefore, the total energy generated over each loading pulse was calculated, as the key indicator to access the energy harvesting ability of the vibration-based energy harvester, as shown in Equation 10.

$${E}_{r} = {\int }_{{t}_{0}}^{{t}_{0} + T} \frac{{V}_{out}^{2}}{{R}_{external}} dt \qquad [ 10 ]$$

Where, t₀ is the starting time point; T is the time duration of one loading pulse; Rₑₓₜₑᵣₙₐₗ is the external resistor connected with the MFC; Vₒᵤₜ is the recorded voltage output signal from an oscilloscope; and dt is the time sampling interval set in the oscilloscope.

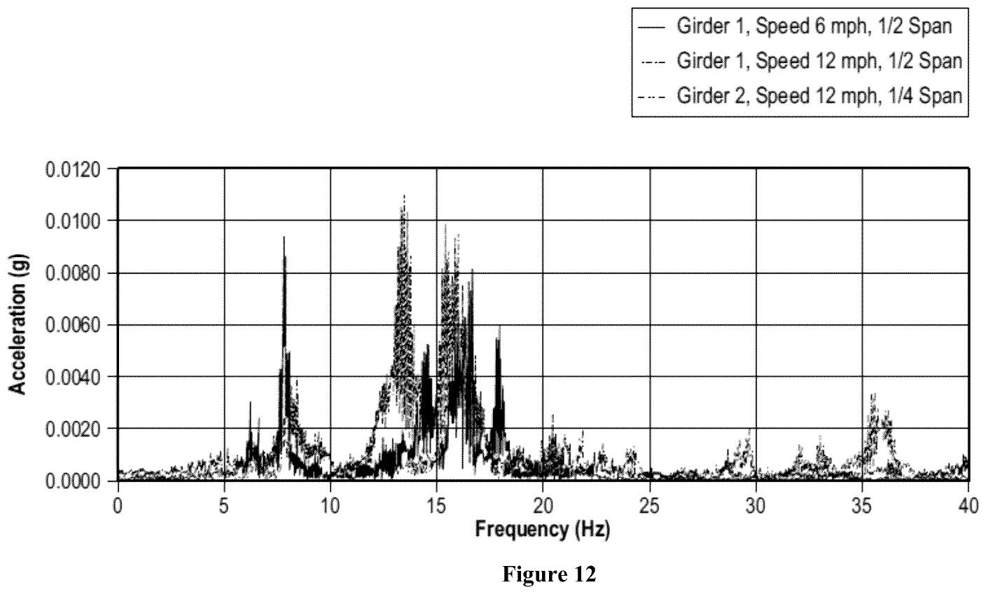

FIG. 12 illustrates Fast Fourier Transform applied to acceleration signals of a bridge. As previously mentioned, when determining dominating acceleration frequencies of the host structure from received acceleration signals, a FFT can be applied. The results of the FFT on the captured acceleration signals from the test cases (e.g., using BEAST) are shown in FIG. 12. The detailed resonant frequencies of acceleration signals from different locations under different speeds are summarized in Table 1. As can be seen through Table 1, three significant acceleration peaks were consistently observed from girder 1, while two significant acceleration peaks were observed from girder 2. Among those vibration frequencies, as the loading speed was changed from 6 mph to 12 mph, the frequency of one vibration mode was shifted from 18 Hz to 16.5 Hz for girder 2 and from 18 Hz to 13.6 Hz for girder 1. The vibration frequency of 16 Hz also was a general one observed from the entire BEAST structure regardless the location or the loading speed.

TABLE 1
Vibration Frequencies Measured in BEAST

Main Vibration Frequencies (Hz)

| | Girder 1, ½ | Girder 2, ½ | Girder 2, ¼ |
|---|---|---|---|
| | Span | Span | Span |
| Speed 12 mph | 7.8, 13.6, 16.0 | 16.0, 16.5 | 16.0, 16.5 |
| Speed 6 mph | 7.8, 16.0, 18.0 | 16.0, 18.0 | 16.0, 18.0 |

After the vibration frequencies were captured in the BEAST, the optimized designs for 2-DOF and 3-DOF cantilevers were used, trying to match their resonant frequencies with the vibration frequencies from the BEAST. Given multiple vibration frequencies were changed by different locations and loading speeds, the targeted resonant frequencies were selected to be 7.8 Hz and 16 Hz for 2-DOF cantilevers, and 7.8 Hz, 13.6 Hz, and 16 Hz for 3-DOF cantilevers in this study.

Based on regression models shown through Equations [5]-[9], the optimized mass combination for 2-DOF and 3-DOF were quantitatively targeted: for 2-DOF, the mass on the main beam was set to 29 g and the mass on the secondary beam was set to 10 g; for 3-DOF, the mass selections from the main beam to the most inner beam were subsequently set to 10 g, 14 g, and 25 g. Based on the regression model results, the optimized 2-DOF cantilever was expected to achieve 7.9 Hz and 15.7 Hz resonant frequencies, while the optimized 3-DOF cantilever was expected to achieve 7.7 Hz, 13.8 Hz, and 22.1 Hz resonant frequencies.

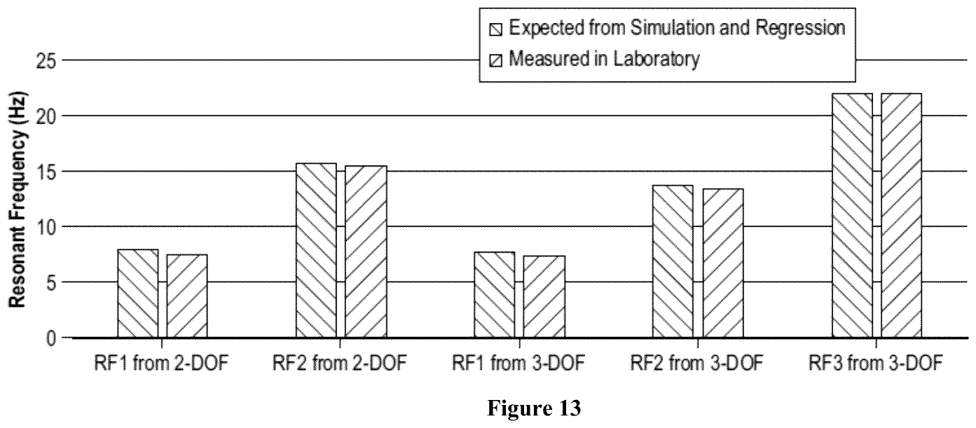

Prior to setting those optimized cantilevers on the BEAST, the resonant frequencies of those two optimized cantilevers were measured in the laboratory. FIG. 13 illustrates resonant frequencies of cantilever beam designs measured in the laboratory versus estimated using FEMs. As shown in FIG. 13, the resonant frequencies measured in the laboratory were close to those expected from FEMs, which were also close to the dominating vibration frequencies captured in BEAST. These matched resonant frequencies confirmed the reliability of simulation models and regression models developed in this study to confidently control the resonant frequencies for reaching the desired values on design optimization purpose.

With confirmed resonant frequencies, the optimized 2-DOF and 3-DOF cantilever designs were set on all three locations of two girders in the BEAST and their voltage outputs from MFCs crossing the external resistors were captured under each loading pulse. Based on Equation [10], the total energy generated by each MFC set on the cantilever was quantified. For comparison purpose, the total energy from MFC set on the other 2-DOF and 3-DOF cantilever designs without matching frequencies were also captured at the same locations on those two girders.

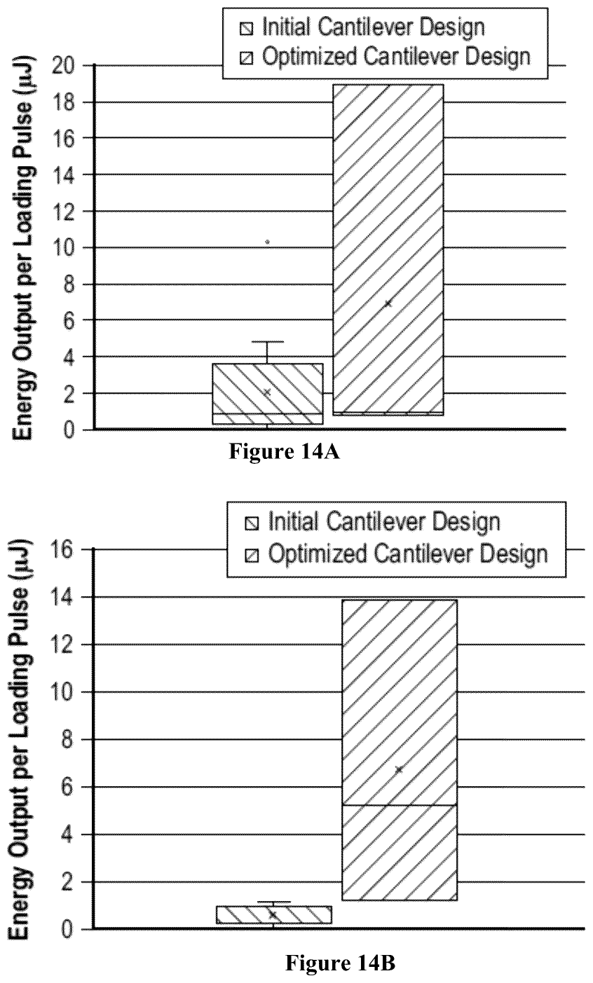

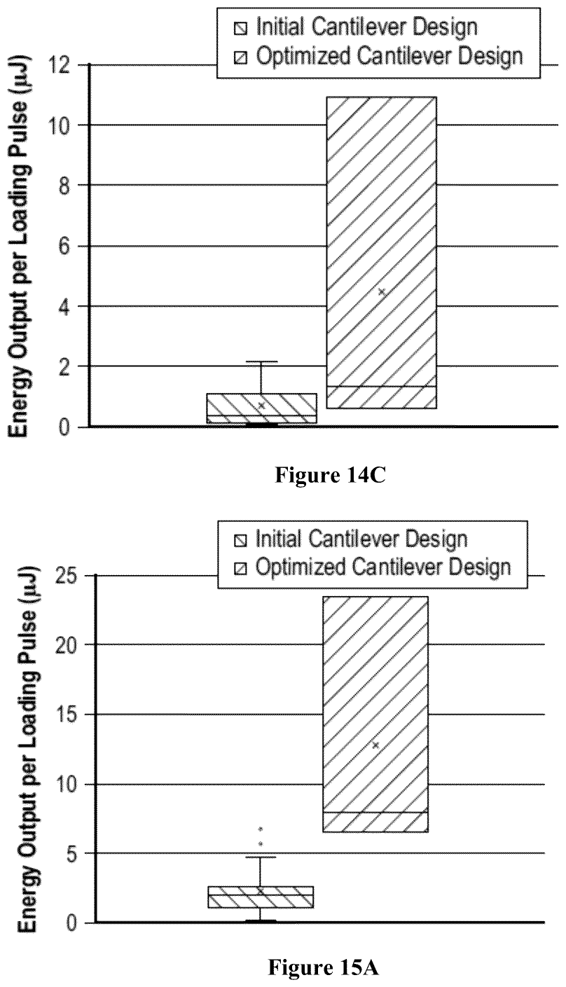

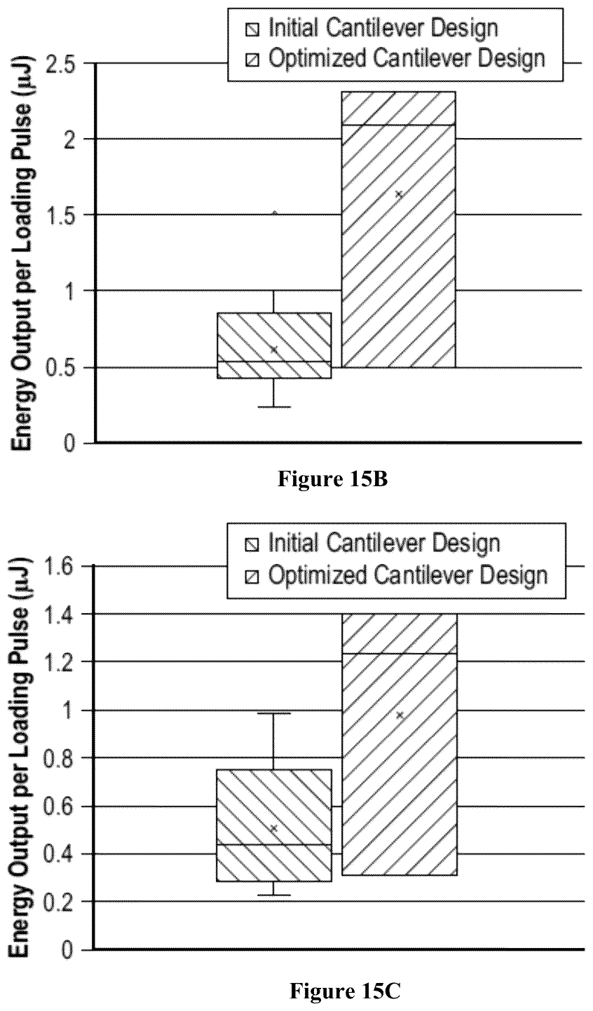

FIGS. 14A-14C illustrate energy outputs from an initial cantilever design versus an optimized cantilever design in a two degree-of-freedom cantilever beam. FIGS. 15A-15C illustrate energy outputs from an initial cantilever design versus an optimized cantilever design in a three degree-of-freedom cantilever beam.

As a general result, displayed in FIGS. 14A-14C and 15A-15C, after the cantilever designs were adjusted by using the optimized mass combinations, the energy outputs from 2-DOF and 3-DOF cantilevers were improved in general, while the maximum energy outputs from both cantilever designs were significantly improved by even more than 200%. These outstanding energy output improvements demonstrate the feasibility of the entire cantilever design optimization strategy proposed in this study.

In detail, as shown in FIGS. 14A-14C, the 2-DOF cantilever showed a more consistently improved energy harvesting performance over three locations, due to its resonant frequencies partially matching the vibration frequencies over all three locations. For 3-DOF cantilever, FIGS. 15A-15C shows that it did generate significantly higher energy outputs at Girder 1 as expected, due to all three resonant frequencies did match the host structural vibration frequencies as much as possible.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A computer-implemented method of automated design for a vibration-based energy harvesting system for a host structure, comprising:
receiving acceleration signals obtained from one or more accelerometers attached to the host structure;
determining dominating acceleration frequencies of the host structure from the received acceleration signals;
determining a degree-of-freedom number of a cantilever beam based on the number of dominating acceleration frequencies of the host structure;
simulating vibration of the cantilever beam across a plurality of parameters;
determining values of the plurality of parameters that result in a match between resonant frequencies of the cantilever beam and the dominating acceleration frequencies of the host structure, wherein the plurality of parameters comprises a length and a width of the cantilever beam, a mass for each degree-of-freedom, positioning information of the mass for each degree-of-freedom, positioning information for a plurality of piezoelectric elements, geometric information of a first internal beam of the cantilever beam, a position of the first internal beam within the cantilever beam, or a combination thereof; and
outputting a proposed design of the cantilever beam comprising the values of the plurality of parameters.

2. The method of claim 1, wherein the number of dominating acceleration frequencies is two or three.

3. The method of claim 2, wherein the determined degree-of-freedom number of the cantilever beam is two when the number of dominating acceleration frequencies of the host structure is two and the determined degree-of-freedom number of the cantilever beam is three when the number of dominating acceleration frequencies of the host structure is three.

4. The method of claim 3, wherein when the determined degree-of-freedom number of the cantilever beam is two, a first mass is coupled to a fixed end of the cantilever beam and a second mass is coupled to the first internal beam of the cantilever beam.

5. The method of claim 3, wherein when the determined degree-of-freedom number of the cantilever beam is three, the plurality of parameters further comprises geometric information of a second internal beam of the cantilever beam, and a position of the second internal beam within the cantilever beam and substantially within the first internal beam of the cantilever beam.

6. The method of claim 5, wherein a first mass is coupled to a fixed end of the cantilever beam, a second mass is coupled to the first internal beam of the cantilever beam, and a third mass is coupled to the second internal beam.

7. The method of claim 6, wherein the first internal beam comprises a fixed end proximal to the fixed end of the cantilever beam and a free end distal to the fixed end of the cantilever beam, wherein the second internal beam comprises a fixed end distal to the fixed end of the cantilever beam and a free end proximal to the fixed end of the cantilever beam.

8. The method of claim 7, wherein the second mass is coupled proximally to the free end of the first internal beam and the third mass is coupled proximally to the free end of the second internal beam.

9. The method of claim 1, wherein determining dominating acceleration frequencies of the host structure from the received acceleration signals comprises processing the received acceleration signals through a Fast Fourier Transform to determine the dominating acceleration frequencies of the host structure.

10. The method of claim 1, wherein the mass for each degree-of-freedom is integrated into the cantilever beam.

11. A system for energy harvesting of infrastructure vibrations, comprising:
a cantilever beam comprising a first internal beam, a fixed end, and a free end;
a first mass coupled to the fixed end of the cantilever beam;
a second mass coupled to the first internal beam of the cantilever beam; and
a plurality of piezoelectric elements coupled to the cantilever beam,
wherein values of a plurality of parameters for the cantilever beam are determined to match resonant frequencies of the cantilever beam to vibration frequencies of a host structure, wherein the plurality of parameters comprises a length and a width of the cantilever beam, the first mass, the second mass, positioning information of the first mass and the second mass, positioning information for the plurality of piezoelectric elements, geometric information of the first internal beam of the cantilever beam, a position of the first internal beam within the cantilever beam, or a combination thereof.

12. The system of claim 11, wherein the cantilever beam further comprises a second internal beam, wherein the second internal beam is positioned substantially within the first internal beam.

13. The system of claim 12, further comprising a third mass coupled to the second internal beam.

14. The system of claim 13, wherein the first internal beam comprises a fixed end proximal to the fixed end of the cantilever beam and a free end distal to the fixed end of the cantilever beam, wherein the second internal beam comprises a fixed end distal to the fixed end of the cantilever beam and a free end proximal to the fixed end of the cantilever beam.

15. The system of claim 14, wherein the second mass is coupled proximally to the free end of the first internal beam and the third mass is coupled proximally to the free end of the second internal beam.

16. A system for energy harvesting of infrastructure vibrations, comprising:
a cantilever beam comprising a first internal beam, a fixed end, and a free end;
a first mass integrated into the fixed end of the cantilever beam;
a second mass integrated into the first internal beam of the cantilever beam; and
a plurality of piezoelectric elements coupled to the cantilever beam,
wherein values of a plurality of parameters for the cantilever beam are determined to match resonant frequencies of the cantilever beam to vibration frequencies of a host structure, wherein the plurality of parameters comprises a length and a width of the cantilever beam, the first mass, the second mass, positioning information of the first mass and the second mass, positioning information for the plurality of piezoelectric elements, geometric information of the first internal beam of the cantilever beam, a position of the first internal beam within the cantilever beam, or a combination thereof.

17. The system of claim 16, wherein the cantilever beam further comprises a second internal beam, wherein the second internal beam is positioned substantially within the first internal beam.

18. The system of claim 17, further comprising a third mass integrated into the second internal beam.

19. The system of claim 18, wherein the first internal beam comprises a fixed end proximal to the fixed end of the cantilever beam and a free end distal to the fixed end of the cantilever beam, wherein the second internal beam comprises a fixed end distal to the fixed end of the cantilever beam and a free end proximal to the fixed end of the cantilever beam.

20. The system of claim 19, wherein the second mass is integrated proximally to the free end of the first internal beam and the third mass is integrated proximally to the free end of the second internal beam.
